(19) United States
(12) Patent Application Publication
(10) Pub. No.: US 2009/0165115 A1
(43) Pub. Date: Jun. 25, 2009

(54) Service providing system, gateway, and server

(75) Inventors: Kunihiko Toumura, Hachioji (JP); Masahiko Nakahara, Machida (JP); Takeshi Shibata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd

(21) Appl. No.: 12/285,172

(22) Filed: Sep. 30, 2008

(30) Foreign Application Priority Data
Dec. 25, 2007 (JP) 2007-332003

(51) Int. Cl. H04L 9/32

(52) U.S. Cl. 726/12

(57) ABSTRACT

A large-scale content delivery system may be achieved, which may send a large amount of contents without intensive management of the contents in the server. In a service providing system where a client, a service gateway, and a server are connected to each other through a network, the client sends a first message to the server by way of the service gateway. The service gateway inquires a processing method of the first message from the client of the server by using a second message that includes a part of the first message content. The server replies to the inquiry of the processing method from the service gateway with a program that describes the processing method, and the service gateway processes the first message from the client on the basis of the received processing method.

### CLAIM OF PRIORITY

The present application claims priority from Japanese patent application JP2007-332003 filed on Dec. 25, 2007, the content of which is hereby incorporated by reference into this application.

### BACKGROUND OF THE INVENTION

1. Field of the Invention

The present invention is directed to a service providing system in a distributed environment.

2. Description of the Related Art

The World Wide Web (hereinafter, referred to as the Web), which has become popular since the 1990, now plays a role as a basement of many network services as of 2007.

In the conventional network services, the download-centric data flow has been predominant in such a manner that a server replies to a request of content from a user. However, with the recent introduction of communication mode of a Peer-to-Peer (P2P) or consumer generated media (CGM) such as blogs or image posting sites has caused a considerable increase in uploading traffic, which sends information from the client side to the server side. In addition, upload dedicated services are also used for monitoring using pictures.

Current physical networks have been established under the assumption that downloads are overwhelmingly prevalent in comparison with uploads. For example, Asymmetric Digital Subscriber Line (ADSL), which is used for accessing the Internet in many households, allocates a broad bandwidth for a downlink as compared to an uplink. Moreover, the decrease in downloads lead to a reduction in traffic, which results in a cache downloaded content into a node on the way or allow contents to be delivered near a user in advance by using a contents delivery network (CDN) technology.

However, these technologies can not deal with the increase of upload traffic. First, servers, which are uploading destinations, are located at a small number of bases. Accordingly, when uploads are done in a concurrent, parallel fashion by a group of clients that are distributed over a broad area, a large load may be exerted onto the server. Secondly, traffic is gradually concentrated from the client group aiming at the server, and therefore, traffic congestion may occur if line capacity is exceeded at any one point, which may remarkably decrease the efficiency of the network. Finally, service providers should prepare a large amount of storage beforehand in order to correspond to the amount of information that the user contributes.

A cache system used for high speed Web access generally caches the content provided as a reply in response to a request from the client but not the request itself. This originates from the fact that the general Web services are provided by a system that cannot execute the process without sending the upload content to the server.

The cash server disclosed in JP-A-2002-196969 temporarily buffers the content of a file in a cache located over a communication path when the file is uploaded onto the server and then sends the contents when the line becomes empty. Moreover, when access to the content that has not been sent to the server yet is attempted, the server acquires the content from the cache and then replies to the access request.

### BRIEF SUMMARY OF THE INVENTION

It is assumed in the abovementioned related art that the content to be provided as a reply to the client is placed on the server last, and thus, the peak of the traffic concentration may be reduced. However, the total amount of traffic aiming at the server is not reduced and the amount of storage needed in the server is not reduced.

An object of the present invention is to provide a system that may prevent upload traffic from concentrating loads onto the line/server, and more specifically, a system that may eliminate any necessity of requiring expensive storage space for service providers upon initiation of service provisions.

Another object of the present invention is to provide a system that may dynamically generate a reply to a request of content from a device placed over a communication path so as to be still able to provide the service even when the uploaded content is stored in the device placed over the communication path, and may permanently store the content necessary for the service in the device placed over the communication path.

To achieve the above objects, there is provided a service providing system according to the present invention, where a client, a service gateway, and a server are connected to each other through a network. Here, the client sends a first message to the server through the service gateway, the service gateway inquires a processing method of the first message from the client of the server by using a second message including the content of the first message, the server replies to the inquiry from the service gateway with the processing method, and the service gateway performs a process of the first message from the client based on the received processing method.

To achieve the above objects of the invention, there is provided a service gateway according to the present invention. The service gateway is connected to a client and a server through a network. The service gateway includes a processing unit; a storage unit; and a network interface, wherein the network interface receives a first message sent from the client to the server, the processing unit inquires a processing method of the first message of the server by using a second message including the content of the first message, receives the processing method provided as a reply from the server, processes the first message based on the received processing method, and sends a generated reply message to the client.

Furthermore, there is provided a server according to the present invention. The server is connected to a client via a service gateway through a network. The server includes a processing unit; a storage unit; and a network interface, wherein the network interface receives a second message including the content of a first message to inquire a processing method of the first message from the service gateway that has received the first message that is sent from the client to the server, and the processing unit generates the processing method of the first message, and more preferably a group of templates for a reply message and generation logic for embedding a blank of the template, based on the second message.

According to the present invention, a necessary bandwidth over the network between the service gateway and the server may be reduced by accumulating the data uploaded onto the server onto the service gateway according to the present invention.

In addition, the present invention may shorten the turnaround time of a reply to a request from the client by generating the reply on the service gateway that is located at a physically near position from the client.

Moreover, since the content itself is stored in the storage included in the service gateway, the service provider may reduce the amount of finance required to provide necessary storage upon initiation of services, if the storage is invested by those who upload the content.

### BRIEF DESCRIPTION OF THE DRAWINGS

FIG. 1 is a view schematically illustrating a construction of a distributed service providing system according to the present invention;

FIG. 2 is a construction view illustrating a distributed service providing system according to a first embodiment;

FIG. 3 is a construction view illustrating the service gateway according to the first embodiment;

FIG. 4A is a view illustrating a personal storage table included in the service gateway according to the first embodiment;

FIG. 4B is a view illustrating a logic/template/content cache table included in the service gateway according to the first embodiment;

FIG. 4C is a view illustrating a generated link management table included in the service gateway according to the first embodiment;

FIG. 5A is a view illustrating a content storage location management table included in the server according to the first embodiment;

FIG. 5B is a view illustrating a generation logic/content storage table included in the server according to the first embodiment;

FIG. 6 is a flowchart illustrating an operation when the service gateway according to the first embodiment receives a request from a client;

FIG. 7 is a flowchart illustrating an operation when the service gateway according to the first embodiment receives a reply from the server;

FIG. 8 is a flowchart illustrating an operation when the server according to the first embodiment receives a request;

FIG. 9 is a flowchart illustrating a sequence when the client according to the first embodiment requests a page;

FIG. 10 is a flowchart illustrating a sequence when the client according to the first embodiment contributes content;

FIG. 11 is a view illustrating details (1) on a message exchanged in the sequence according to the first embodiment;

FIG. 12 is a view illustrating details (2) on a message exchanged in the sequence according to the first embodiment;

FIG. 13 is a view illustrating details (3) on a message exchanged in the sequence according to the first embodiment;

FIG. 14 is a view illustrating details (4) on a message exchanged in the sequence according to the first embodiment;

FIG. 15 is a view illustrating details (5) on a message exchanged in the sequence according to the first embodiment;

FIG. 16 is a view illustrating details (6) on a message exchanged in the sequence according to the first embodiment;

FIG. 17 is a construction view illustrating a distributed service providing system according to the first embodiment;

FIG. 18 is a view illustrating a sequence when a client requests a page according to a second embodiment;

FIG. 19 is a view illustrating details (1) on a message exchanged in the sequence according to the second embodiment;

FIG. 20 is a view illustrating details (2) on a message exchanged in the sequence according to the second embodiment;

FIG. 21 is a view illustrating a table included in the user attribute server according to the second embodiment;

FIG. 22 is a construction view illustrating an image monitoring system according to a third embodiment;

FIG. 23 is a view illustrating a sequence when the client requests an image according to the third embodiment;

FIG. 24 is a view illustrating details (1) on a message exchanged in the sequence according to the third embodiment;

FIG. 25 is a view illustrating details (2) on a message exchanged in the sequence according to the third embodiment; and

FIG. 26 is a flowchart illustrating analysis logic according to the third embodiment.

### DETAILED DESCRIPTION OF THE INVENTION

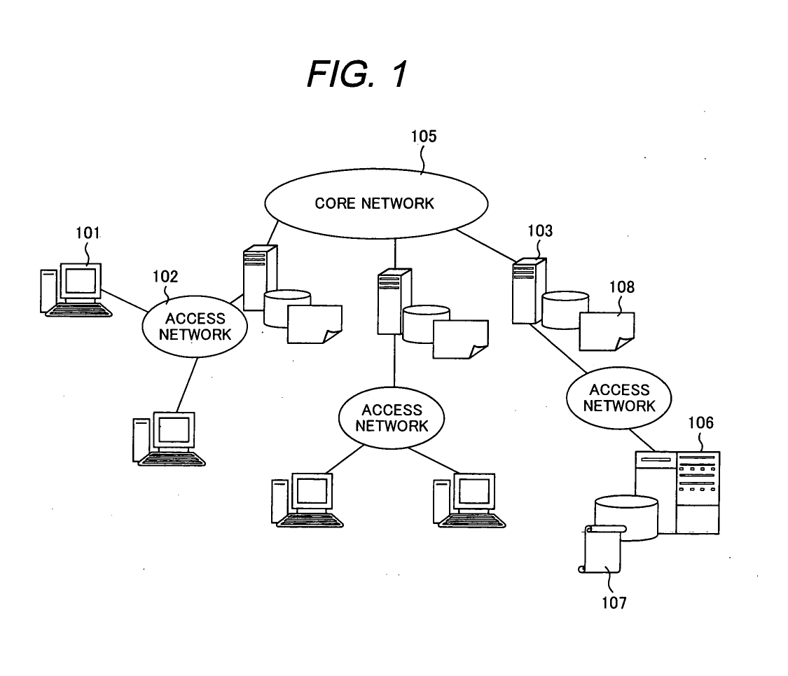

Before various embodiments of the present invention are described, an example of a schematic construction of a service providing system according to the present invention will be described with reference to FIG. 1.

FIG. 1 shows the entire construction of the service providing system. A client 101, a service gateway 103, and a server 106 are connected to each other through networks such as an access network 102 and a core network 105. The client 101 sends a first message to the server 106 via the service gateway 103, and the service gateway 103 inquires a processing method of the message sent from the client 101 of the server 106 by using a second message including a part of the contents of the received first message. The server 106 responds to the inquiry of the processing method from the service gateway 103 with a program on which a processing method has been written. The service gateway 103 processes the message from the client 101 on the basis of the received processing method. Therefore, only a part of the message from the client 101 reaches the server 106, thus making it possible to reduce the amount of traffic.

The service gateway 103 may store the processing method received from the server 106 in a storage unit included in the service gateway 103. This eliminates any necessity of access to the server 106 to respond to a second or later request from the client 101.

The service gateway 103 may store a reply message to the client 101, which is generated according to the processing message, in the storage unit of the service gateway 103. This allows the cost to be reduced when a executing a high generation of processes for a load in respects to replying to a second or later request in terms of static content.

Furthermore, the service gateway 103 may store a part or the whole of the message from the client 101, which is analyzed according to the processing method, in the storage unit of the service gateway 103.

The service gateway 103 allocates a unique identifier to the data stored in the storage unit and sends the identifier to the server 106. By doing this, when receiving a request for a large size content, such as registration of an image, the service gateway 103 stores the large size content in the storage unit, so that the server 106 may manage only the metadata on the content (storage location of the image, its descriptions, its title, and the like), thus enabling the reduction in storage capacity on the side of the server 106.

A method of describing the processing method in the server 106 is preferably expressed as a group of templates of the reply message and a program for embedding a blank of one of the templates. The service gateway generates dynamic content by embedding results of program execution into the blank template.

The service gateway 103 identifies the client 101 by an authorization token included in the message. The term “authorization token” refers to an authorization header or the like in the HTTP. And, this authorization token may also be used to determine whether a request is processed or not.

In addition, a process of receiving an advertisement from an advertisement provider to embed the content of the advertisement into the content may also be performed by describing a means/method for acquiring information necessary for generating the reply message from an external server, such as an advertisement server and the like, as the program of the processing method.

### First Embodiment

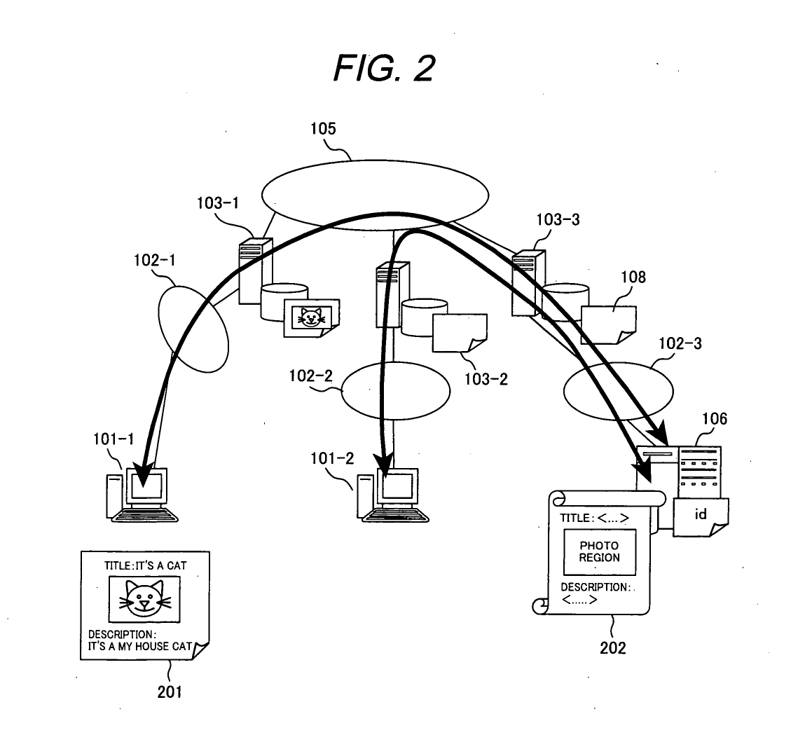

In a distributed service providing system according to the first embodiment, a Web based image registration system will be described. FIG. 2 is a view illustrating an exemplary construction of the distributed service providing system according to the first embodiment.

The distributed service providing system according to the first embodiment includes clients 101-1 and 101-2, access networks 102-1 to 102-3, service gateways 103-1 to 103-3, and a core network 105.

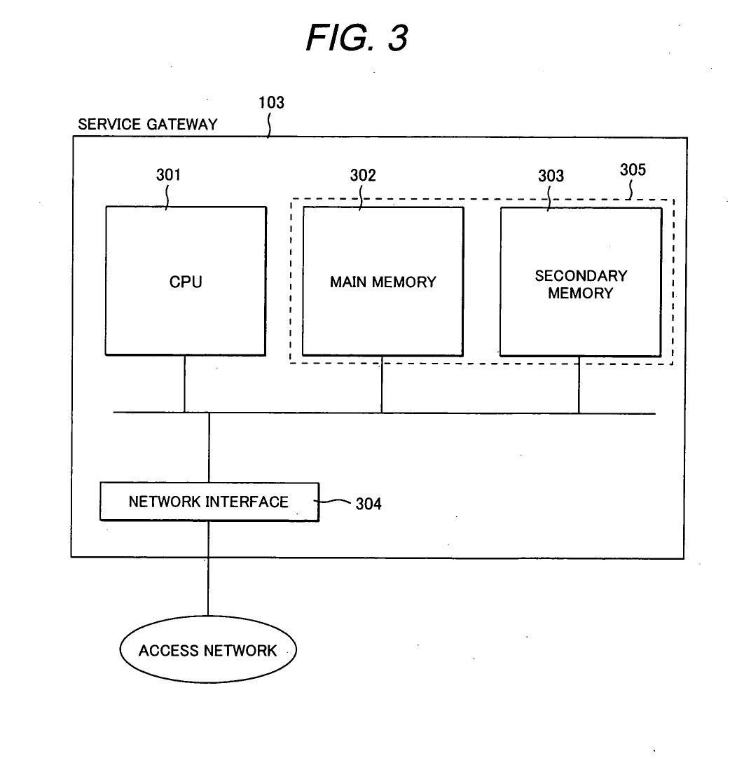

As shown in FIG. 3, the service gateway 103 is a computer which includes a central processing unit (CPU) 301, a main memory 302, a secondary memory 303, and a network interface 304. The main memory 302 and the secondary memory 303 are commonly considered as the same storage unit (memory) in this embodiment, and thus, hereinafter referred to as a memory 305. The network interface 304, which sends and receives data, is connected to the access network 102 and the core network 105. The CPU 301 is implemented to execute a program that corresponds to functions of the service gateway 103 to be described hereafter one by one.

The server 106 and the client 101 are also a computer that has the same construction as that of the service gateway 103. The only difference from the service gateway 103 is that there is a difference in information recorded in the memory 305 from the service gateway 103, and the connection destination of the network interface 304 is the access network 102.

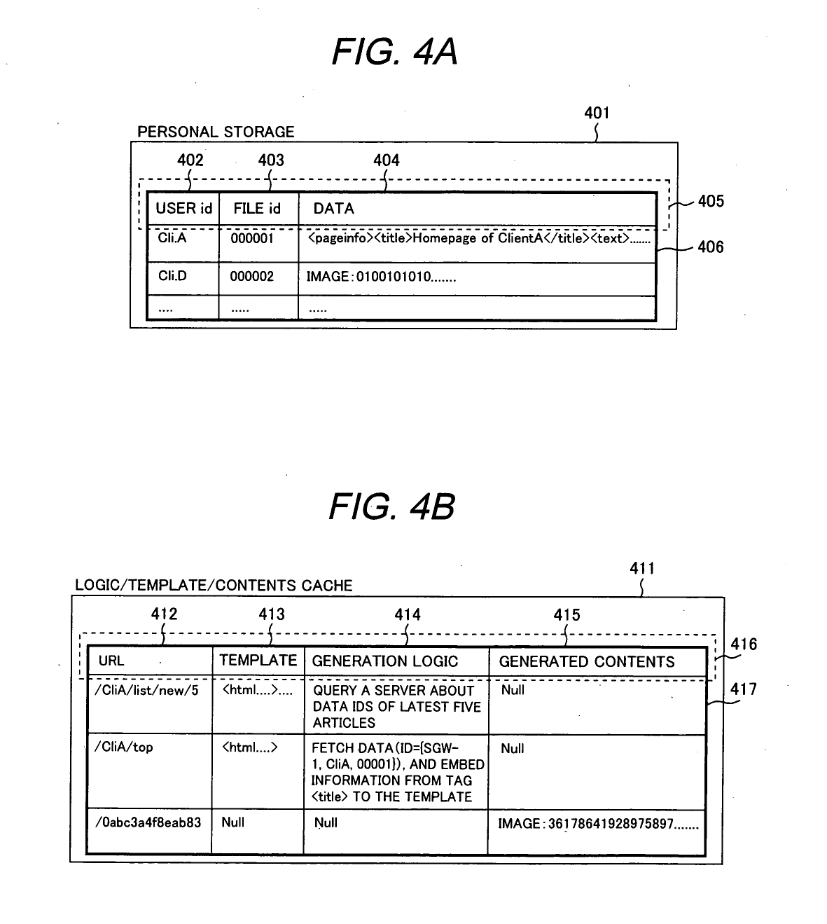

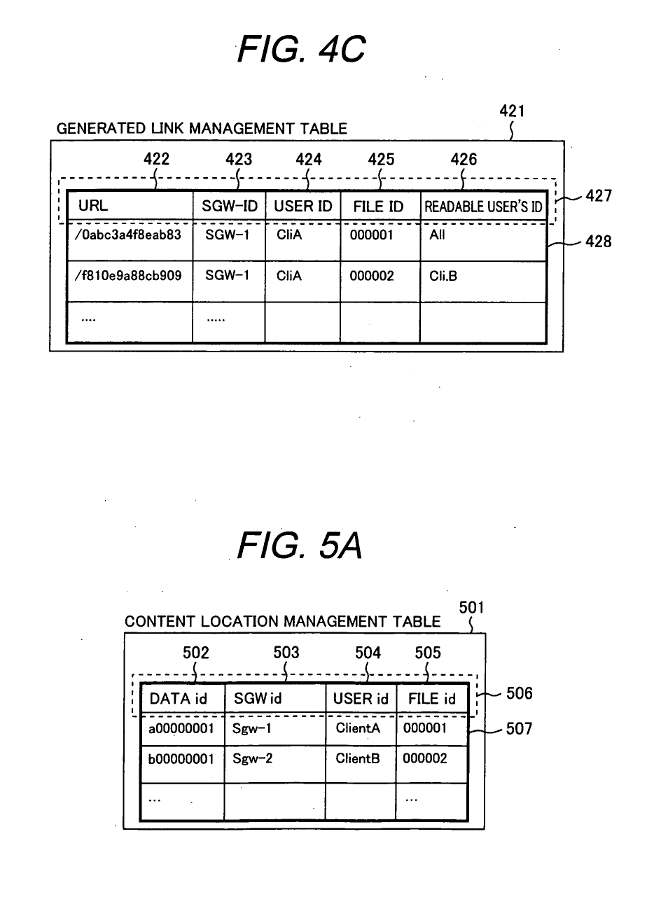

FIGS. 4A, 4B, and 4C are views illustrating table groups that are included in the memory 305 of the service gateway 103.

A personal storage 401 shown in FIG. 4A is a table to store contents for each and every user, and stores identification 405 that is composed of user ID 402, file ID 403, and data 404. The user ID 402 refers to an identifier of a user uniquely determined in the system. The file ID 403 is an identifier of a content storage location uniquely determined in a single service gateway 103. The data 404 refers to the main body of content. For example, an entry 406 refers to an XML document that is registered by “Cli.A” and stored in the location of “000001”.

A logic/template/contents cache 411 shown in FIG. 4B is a table to store operations to be done according to a request from the client 101, and retains an entry 416 that is composed of a URL 412, a template 413, generation logic 414, and generated content 415. The URL 412 is a character string included in the header of a request from the client to represent the content of the request. The template 413 serves as a form when a reply for the client 101 is generated, wherein the reply is made by replacing a specific part in the template by predetermined information in accordance to the program included in the generation logic 414. The generated content 415 is provided to cache reply contents in reply to an instruction from the server, for example when the content of the generated reply content is not changed in the future. For instance, the entry 417 represents information that the URL of the latest five articles are embedded into a specific part of an HTML document represented as the template “<html> . . . ” when a URL including a character string “/CliA/list/new/5” is received from the client. The generated content “Null” included in the entry represents that the latest article information needs to be always inquired by the server and thus there is no record in the cache.

A generated link management table 421 shown in FIG. 4C is a table to manage the URL generated when a reply for the client 101 is made. The user's access is limited according to this table. The table retains an entry 427 that is composed of a URL 422, an SGW-ID 423, a user ID 424, a file ID 425, and a readable user's ID 426. The URL 422 refers to a character string of a generated URL. The SGW-ID 423 refers to an identifier of the former service gateway that obtains the content when there is access to the URL. The user ID 424 refers to the user ID 402 of the content. The file ID 425 refers to the ID of a file in the service gateway 103 in which the content is stored. The readable user's ID 426 refers to the ID of a user who is permitted to gain access by using the URL. For example, the entry 428 represents that upon attempt to access the URL including the character string “/Oabc3a4f8eab83” in the service gateway 103, all the users may receive the content whose user ID is “Cli.A” and file ID is “000001” from the service gateway which has the SGW-ID of “fSGw-1”.

The table groups are stored in the memory 305 included in the service gateway 103.

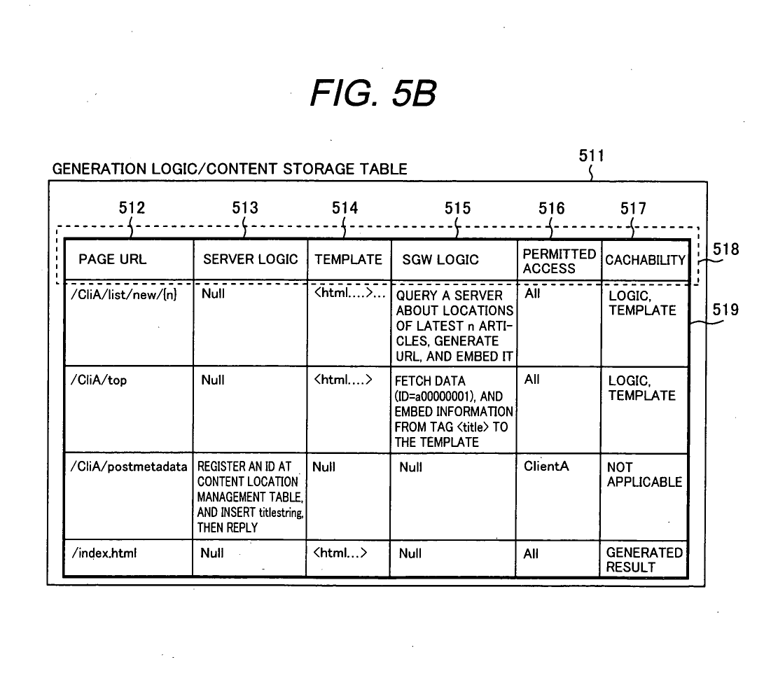

FIGS. 5A and 5B illustrate table groups included in the server 106.

The content storage location management table 501 shown in FIG. 5A is a table to manage the location where contents registered by the client 101 is stored, and stores identification 506 that is composed of a data ID 502, an SGW-ID 503, a user ID 504, and a file ID 505. The data ID502 refers to an identifier of the data uniquely determined in the server 106. The SGW-ID 503 is an identifier of service gateway 103 which stores the content. The user ID 504 is an identifier of the user who registered the contents. The file ID 505 represents the ID of a file which stores the content in the service gateway 103. For instance, the entry 507 represents that the data with the identifier of “a00000001” managed in the server, is managed by the service gateway 103 whose identifier is “Sgw-1”, the user ID of the user who registered the data is “Client A”, and the file ID is “0000001”. All the contents are managed by the data ID in the server.

A generation logic/content storage table 511 shown in FIG. 5B is a table to manage a method of generating a reply to a request from the client 101, and this retains an entry 518 that is composed of a URL 512, server logic 513, a template 514, an SGW generation logic 515, a permitted access 516, and cacheability 517. The URL 512 refers to a character string included in the header of the request from the client to retain the content of the request. The server logic 513 refers to a content generation rule at the side of the server when there is a request in the URL. When there is no description in the server logic, a value including the template 514 and the SGW generation logic 515 to be described below in the service gateway 103 is provided as a reply. The template 514 refers to a template to be provided as a reply to the service gateway 103 when the request for the URL is received. The SGW generation logic 515 refers to a program to be executed to generate content for the URL in the service gateway 103. The permitted access 516 stores the ID of a user who may gain access to the content. “All” in the permitted access 516 means that any content may be freely accessible from all users. The cacheability 517 refers to an element that can be permanently stored in the service gateway 103. In the entry 519, for instance, when the server 106 receives a request that matches a pattern of “/CliA/list/new/{n}”, the server replies with a program of inquiring the service gateway about the template “<html . . . >” and the location of data ID associated with the latest n articles, generating a URL, and embedding it. At this time, the access to the content is free and template and SGW logic provided as a reply may be stored in the logic/template/contents cache 411 included in the service gateway 103.

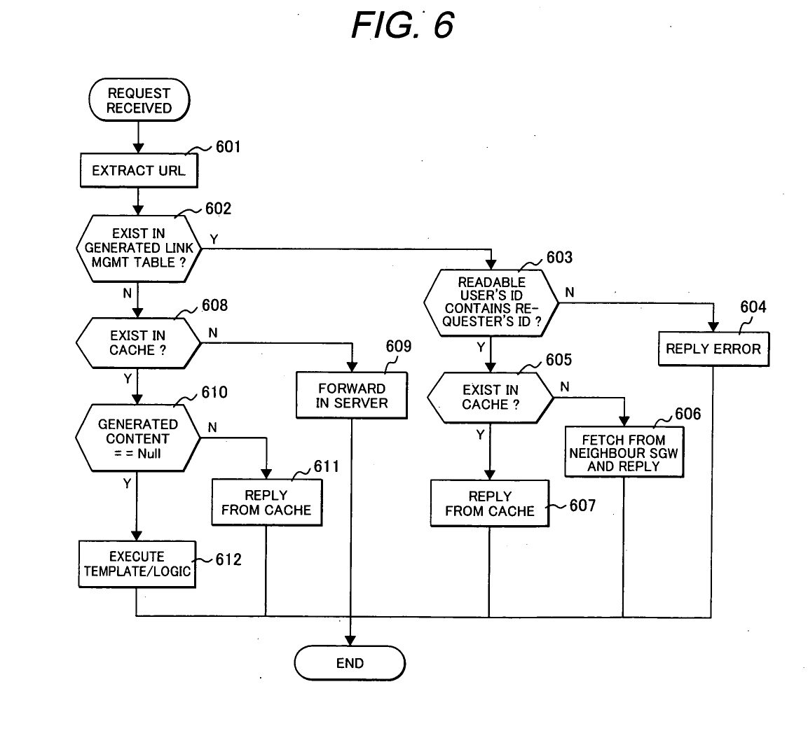

FIG. 6 is a view illustrating a processing flow in the CPU 301 when the service gateway 103 receives a request from the client 101.

Firstly, when the service gateway 103 receives a request from the client 101, the CPU 301 extracts URL from the header of the request (step 601). Next, the CPU 301 retrieves the generated link management table 421 by using the URL as a key (step 602). The CPU 301 examines whether the user ID of the transmission source of the request is included in the readable user's ID 426 of the entry when the entry exists in the generated link management table 421 (step 603). When the user ID of the transmission source is not included in the readable user's ID 426, this access is not permitted and thus the CPU 301 returns an error to the client 101 (step 604). The CPU 301 retrieves the logic/template/contents cache 411 by using the URL as a key when the user ID of the transmission source is included in the readable user's ID 426 (step 605). When no entry does not exist in the cache, the CPU 301 extracts the SWG-ID 423 included in the entry of the generated link management table 421 and acquires content of the user ID and the file ID included in the entry from the service gateway 103 indicated by the ID. And, after registering the reply in the logic/template/contents cache 411, the CPU 301 provides the content to the client as a reply (step 606). When any entry exists in the logic/template/contents cash 411, the CPU 301 provides the content shown in the generated content 415 of the entry to the client as a reply (step 607).

Next, when the URL doesn't exist in the generated link management table in the step 602, the CPU 301 retrieves the logic/template/contents cache 411 by using the URL as a key (step 608). When no entry exists, the service gateway forwards the request from the client to server 106 as it is (step 609). When an entry exists, the CPU 301 examines whether the content shown in the generated content 415 is “Null” or not (step 610). When the content shown in the generated content is not “Null”, the CPU 301 provides the content shown in the generated content 415 to the client as a reply (step 611). When the content shown in the generated content 415 is “Null”, the CPU 301 generates content according to the template 413 and the generation logic 414 and provides the generated content to the client as a reply (step 612).

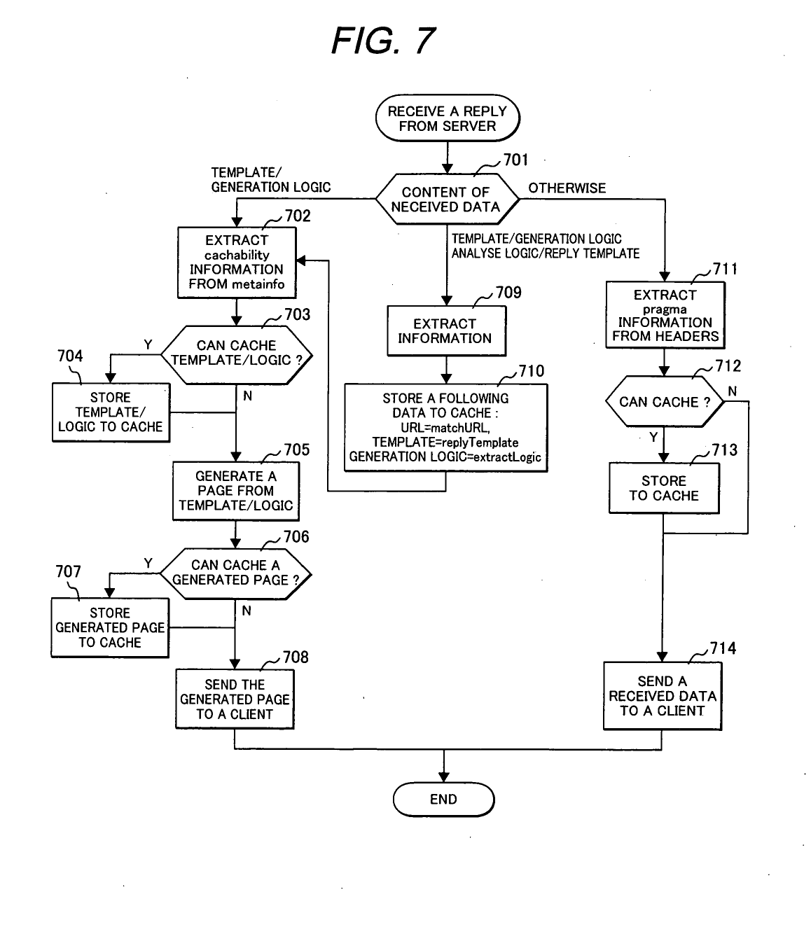

FIG. 7 shows a processing flow in the CPU 301 when the service gateway 103 receives a reply to the request sent from the service gateway 103 to the server 106 in the step 609.

The process is divided into three depending on whether the content received from the server 106 is template/generation logic, template/generation logic/analysis logic/reply template, or other replies (step 701). When the template/generation logic is provided as a reply, the CPU 301 extracts cacheability information from the reply (step 702). The CPU 301 examines whether it is described as the template/logic that may be cached as cacheability information (step 703). If the template/logic may be cached, the CPU 301 registers the template/generation logic in the logic/template/contents cache 411 by using the URL included in the reply as a key (step 704). If the template/logic may not be cached or registration to the cache has been completed, the CPU 301 generates a reply page according to the template/generation logic (step 705). The CPU 301 examines the cacheability information again herein to examine whether the generated page may be cached or not (step 706). When the generated page may be cached, the CPU 301 stores the generated page in the cache similarly to the step 704 (step 707). When the generated page may not be cached or has been completed to be stored in the cache, the CPU 301 sends generated page back to the client (step 708).

When the reception content is determined as the template/generation logic/analysis logic/reply template in the step 701, the CPU 301 extracts various types of information from the reply (step 709). Further, the CPU 301 registers the analysis logic and the reply template in the logic/template/contents cache 411 as the generation logic and the template, respectively, by using the URL included in the reply as a key (step 710). Thereafter, the CPU 301 executes processes from step 702 to step 708 to reply to the client 101. The CPU 301 performs processes similar to those of a general Web cache when the other determination is made in step 701. That is, the CPU 301 extracts the cacheability of the content from the pragma header information included in the reply (step 711). The CPU 301 stores the content designated by the generated content 415 included in the logic/template/contents cache 411 as cacheability by using the requested URL as a key (step 713). Then, the CPU 301 provides the reception content as a reply to the client 101 as it is (step 714).

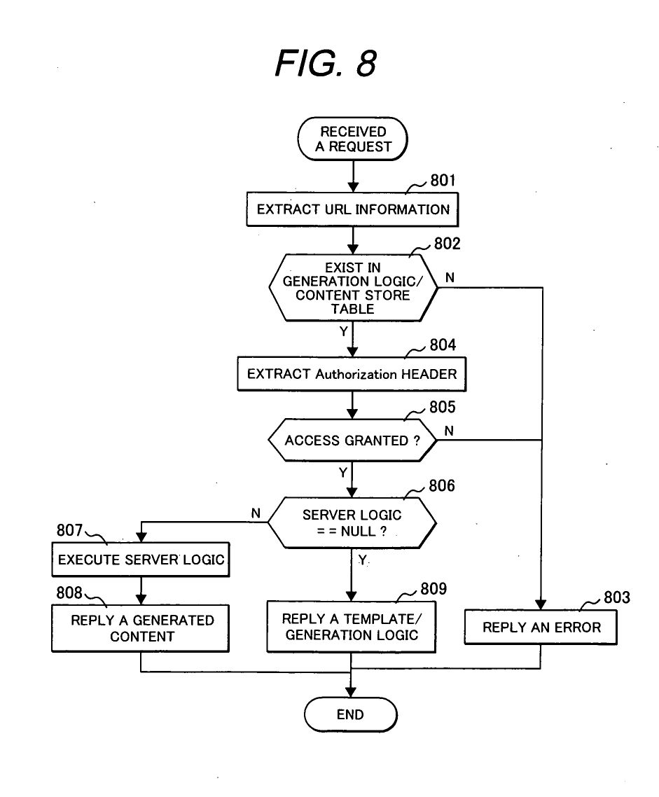

FIG. 8 shows a processing flow in the CPU of the server 106 when the server 106 receives a request.

The server 106 extracts URL information from the request sent from the service gateway 103 (step 801). The server 106 retrieves the generation logic/content storage table 511 by using the URL as a key (step 802). If no entry exists in the generation logic/content storage table 511, the server 106 replies the service gateway with an error reply (step 803). If an entry exists in the generation logic/content storage table 511, the server 106 extracts the authorization header included in the header of the request as the user ID (step 804). And then, the server 106 combines the extracted authorization header with the permitted access information 516 of the entry (step 805). If access is not granted, the process proceeds to step 803 to reply with an error. If access is granted, the server 106 refers to the server logic 513 of the entry to examine whether the value is “Null” or not (step 806). If the value is not Null, the server 106 executes the program stored in the server logic 513 of the entry (step 807) to generate a reply and replies to the service gateway 103 with the generated reply (step 808). If the value is Null in the step 806, the server 106 replies with the template 514 and the SGW generation logic 515 included in the entry (step 809).

Hereinafter, examples of a typical sequence and a message exchanged at the time of the sequence will be described according to an embodiment.

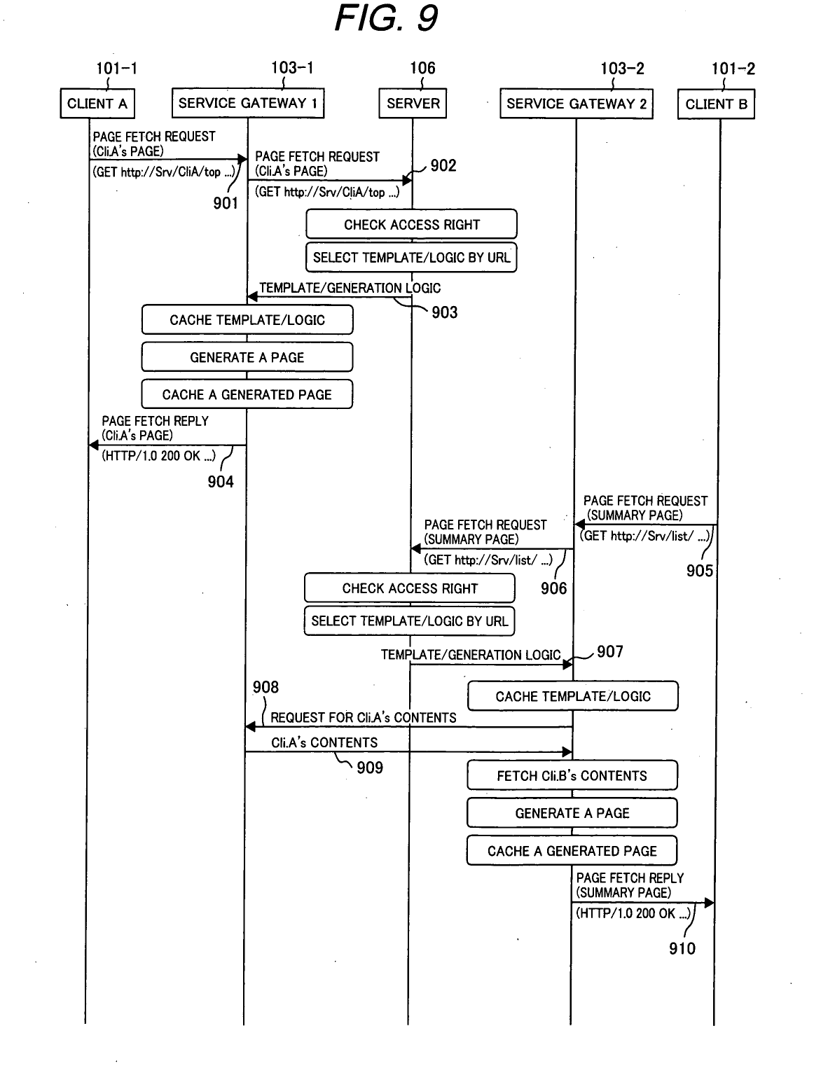

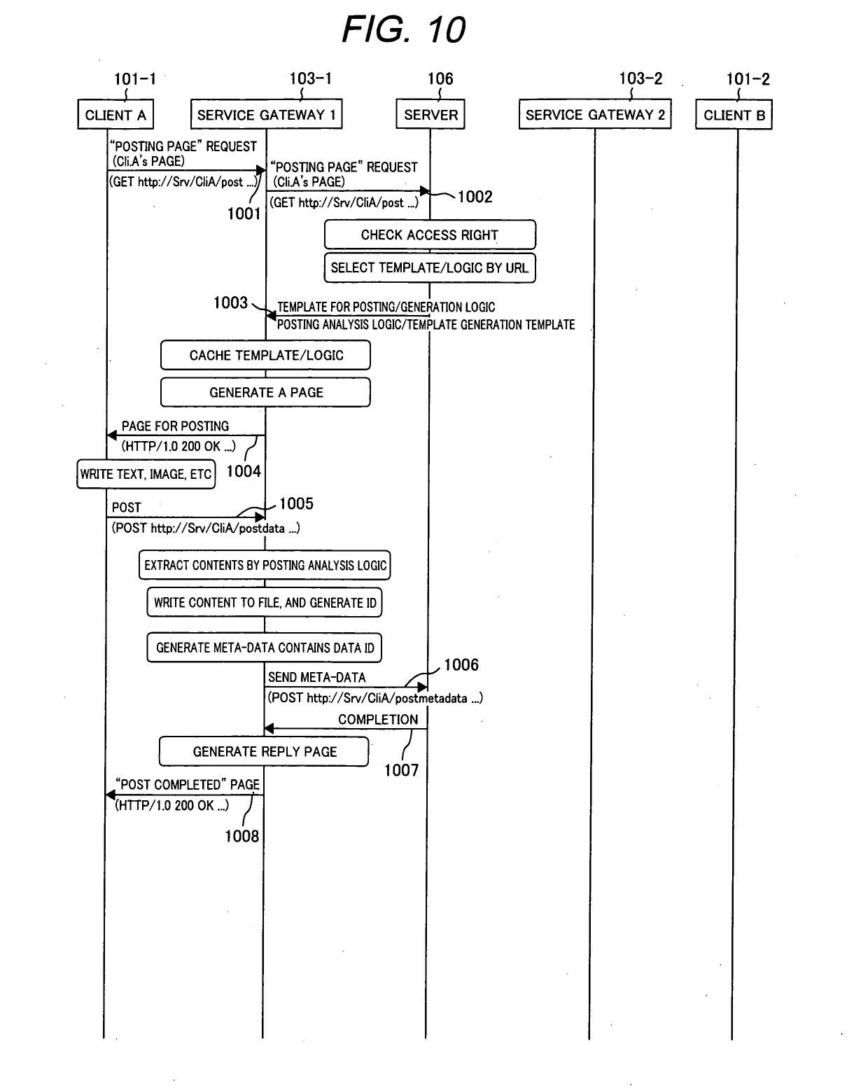

FIG. 9 shows a sequence that a client A 101-1 acquires a page that is registered and a sequence that a client B 101-2 acquires a list page in the first embodiment.

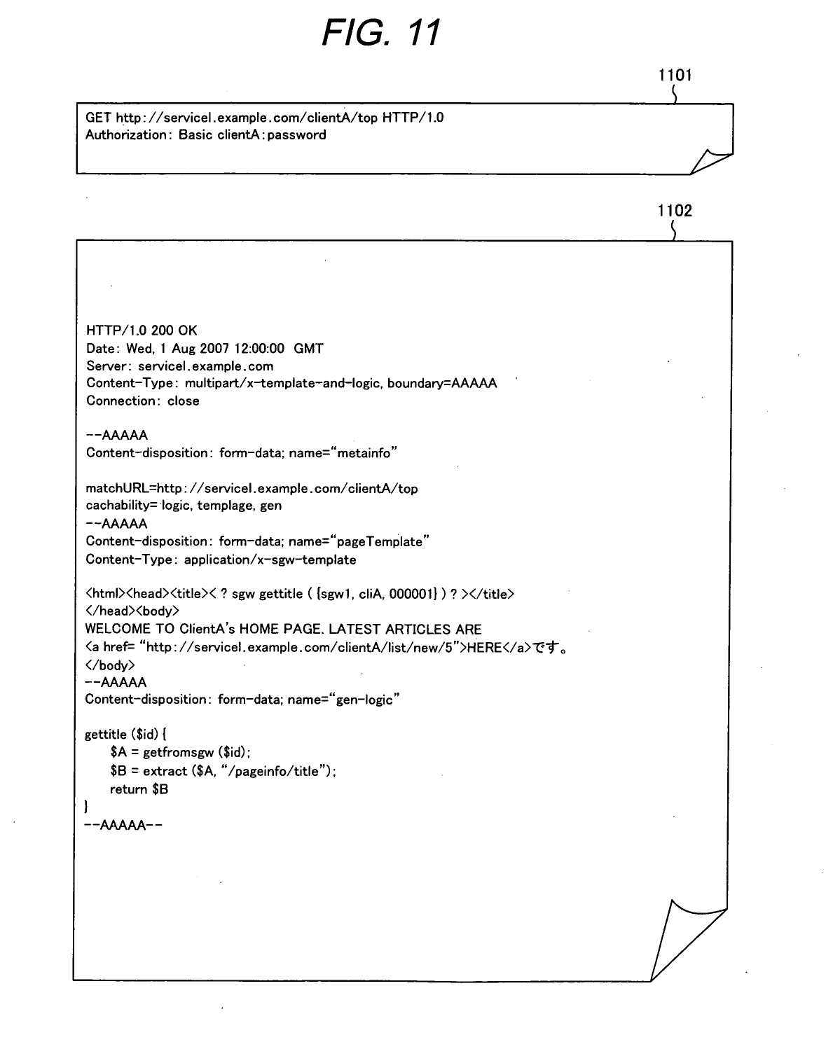

In the process 901, client A 101-1 sends the server 106 a page fetch request with a first message through the service gateway 1 103-1. Details on the first message sent during process 901 are shown in the message 1101 in FIG. 11. A URL that represents a registration page registered by the client A 101-1 is included in this message. Additionally, the user/password part of the authorization header is BASE64-encoded when the request is issued in accordance to HTTP, however, plaintext is represented herein for simplicity of description. The authorization token on HTTP is used in this embodiment, but user ID may be extracted from other information such as IP addresses, MAC addresses, or physical line information, etc. The service gateway 1 103-1 which received this message 1101 performs a process according to the flow of FIG. 6. In this example, the message 1101 is sent to the server 106 as it is in the process 609 as the second message assuming that the entry does not exist in the generated link management table 421 and the logic/template/contents cache 411 (902).

The server 106 that has received the sent message performs a process according to the flow of FIG. 8. In this example, the server 106 performs a matching process on the second entry included in the generation logic/contents storage table 511 in step 802, examines whether a permitted access exists in step 805, determines the server logic is Null in step 806, and then performs step 809. When the server replies the service gateway, the data ID included in the template 514 and the SGW generation logic 515 is converted into a group of the SGW-ID 503, user ID 504, and the file ID 505 according to the content storage position management table 501 and then the converted result is sent (903).

Details on the message sent in process 903 are shown in the message 1102 in FIG. 11. The message 1102 includes URL information, cacheability information template, and generation logic.

The service gateway 1 103-1, which has received the reply from the server 106, performs a process according to the flow process shown in FIG. 7. Further to step 702, steps 703 to 708 are performed in this example, assuming that the generation logic, the template, and the generated page may be cached as cacheability information included in the message in order to receive the message 1102 including the template/generation logic.

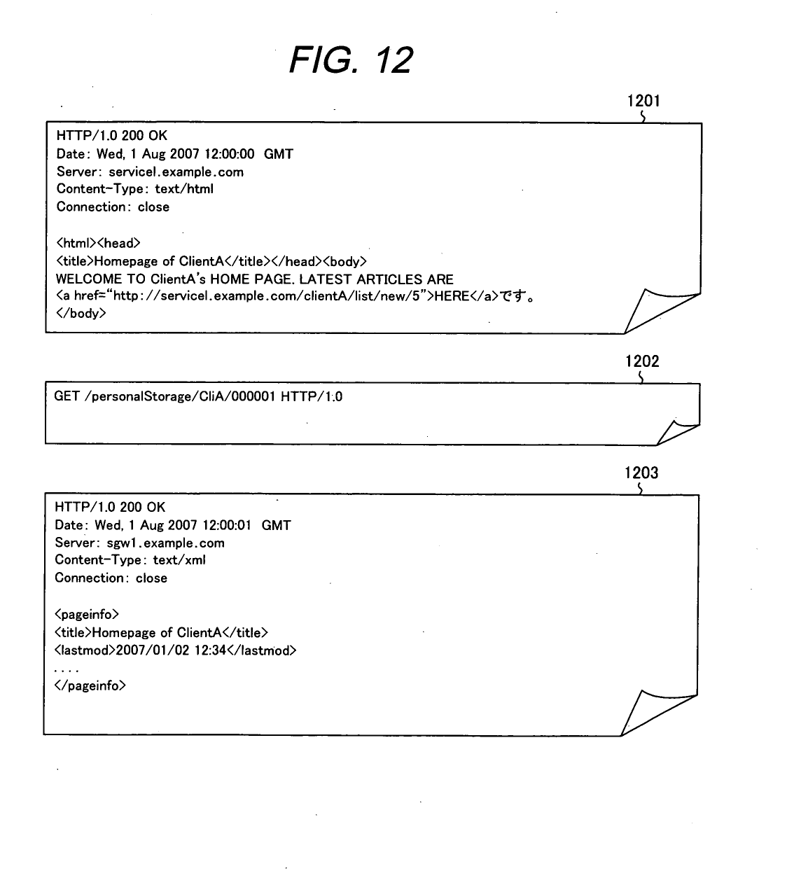

The generated content is sent from the service gateway 1 103-1 to the client A 101-1 in the process 904. The reply message sent herein is shown in the message 1201 in FIG. 12. In the message 1201, a part of the template represented as “<?sgw . . . ?>” included in the message 1102 is replaced with a result of execution of the generation logic. As a result, it has been shown that the server provides only the logic and generates the page by using the content stored in the memory included in the service gateway.

Next, a sequence will be described when a list page fetch request is sent from a client 101 that belongs to a different service gateway 103.

A client B 101-2 makes a list page fetch request to the server 106 through a service gateway 2 103-2 (905). A first message sent herein is a variation to the message 1101, where the URL, the user ID, and the password part have been changed, and thus, the detailed description will be omitted. The service gateway 2 103-2, which has received the message, sends the message to the server assuming that the entry does not exist in the generated link management table 421 and the logic/template/contents cache 411 (906). The server 106 checks the permitted access and selects an appropriate entry from the generation logic/storage table 511 to reply to the service gateway 2 103-2 (907).

After storing the template/generation logic in the cache appropriately, the service gateway 2 103-2, which has received the reply, generates the contents. It is assumed herein that logic that performs data fetch from the neighboring service gateway 1 103-1 is performed by the generation logic. The service gateway 2 103-2 makes a content fetch request of the content belonging to the client A to the service gateway 1 103-1 according to this logic (908). The message sent herein is shown in the message 1202 in FIG. 12. The communication between the service gateways 103 is assumed to be done by using HTTP herein. This message expresses the fetch request on necessary content by embedding the user ID and the file ID into the URL. The service gateway 1 103-1 that has received the message 1201 extracts the entry from the personal storage 401 and replies the service gateway 2 103-2 (909). At this time, the outgoing message is shown in the message 1203 in FIG. 12.

The service gateway 2 103-2 generates a page by using the content included in the message 1203, and replies a client B 101-2 with the generated page (910). As a result, it has been shown that the content is sent and cached appropriately between clients that belong to a different service gateway 103.

Finally, a sequence will be described when client A 101-1 contributes contents.

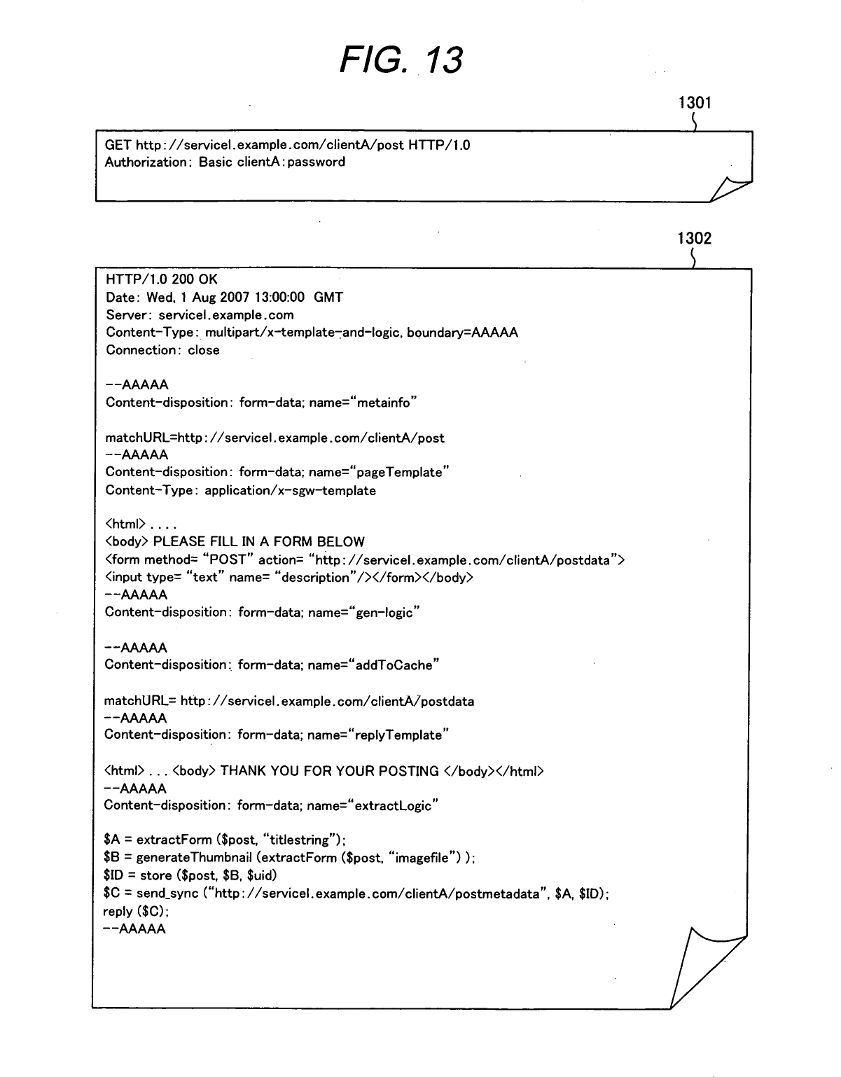

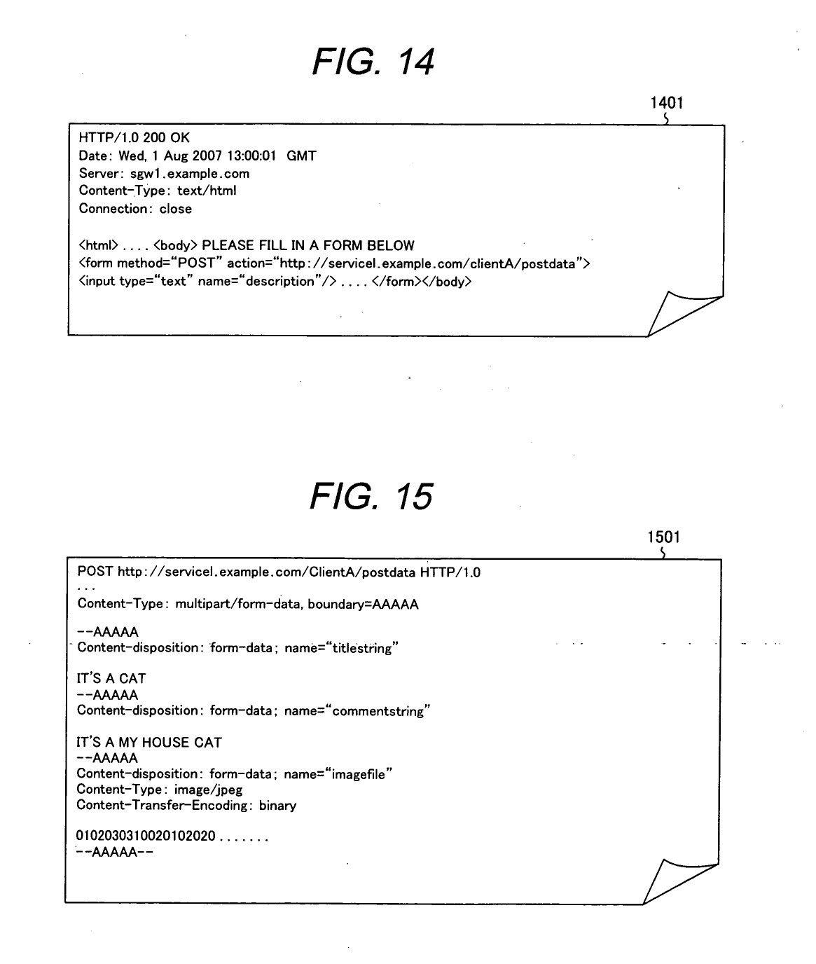

Client A 101-1 sends a posting page request to the server 106 through the service gateway 1 103-1 (1001). A first message sent in process 1001 is shown in the message 1301 in FIG. 13. When the service gateway 1 103-1 receives the message 1301, the service gateway 1 103-1 sends the message 1301 to the server 106. Here, the same message as the message 1301 is similarly sent as a second message (1002). The server 106 that has received the message processes the request according to the flow shown in FIG. 8. It is assumed herein that the entry including the template/generation logic for the generation of a page for posting and the template/generation logic for the analysis of a posting request exists for the URL included in the request and a reply is provided to the service gateway 1 103-1 based on the entry (1003). The reply message sent at this time is shown in the message 1302 in FIG. 13. The message 1302 is divided into six parts with respect to the character string “-AAAAA”, which are request source URL information, template, generation logic, additive URL, template, and generation logic, respectively. The service gateway 1 103-1, which has received the message 1302, adds the additive URL, the template, and the generation logic placed to the latter half of the message into the logic/template/contents cache 411 according to steps 709 and 710 and then generates a reply according to the request source URL information, the template, and the generation logic placed in the former half of the message. The service gateway 1 103-1 replies to client A with the generated page (1004). The generated message is shown in the message 1401 in FIG. 14.

Client A 101-1 performs the posting process by using the form included in the page generated herein. Specifically, client A 101-1 sends a POST request including the content according to the URL included in the form (1005). The message sent in process 1005 is shown in the message 1501 in FIG. 15. The title of the image, the description of the image, and the image file are included in the message 1501 as the posting content.

The service gateway 1 103-1, which has received the message 1501, performs a process according to the flow process of FIG. 6. Here, even though the entry does not exist in the generated link management table 421 but in the logic/template/template/contents cache 411 since the template and the logic for the request analysis were registered in process 1004, the generated content 415 is treated as Null, so that the logic and template for the request analysis are used. A process of registering the image title, the image description, the image file, and the thumbnail of the image file to the personal storage 401, sending the service gateway ID, the user ID, the file ID, and the image title of the registration destination to the server 106, and generating a post completed page with the template is described in the request analysis logic included in the message 1302.

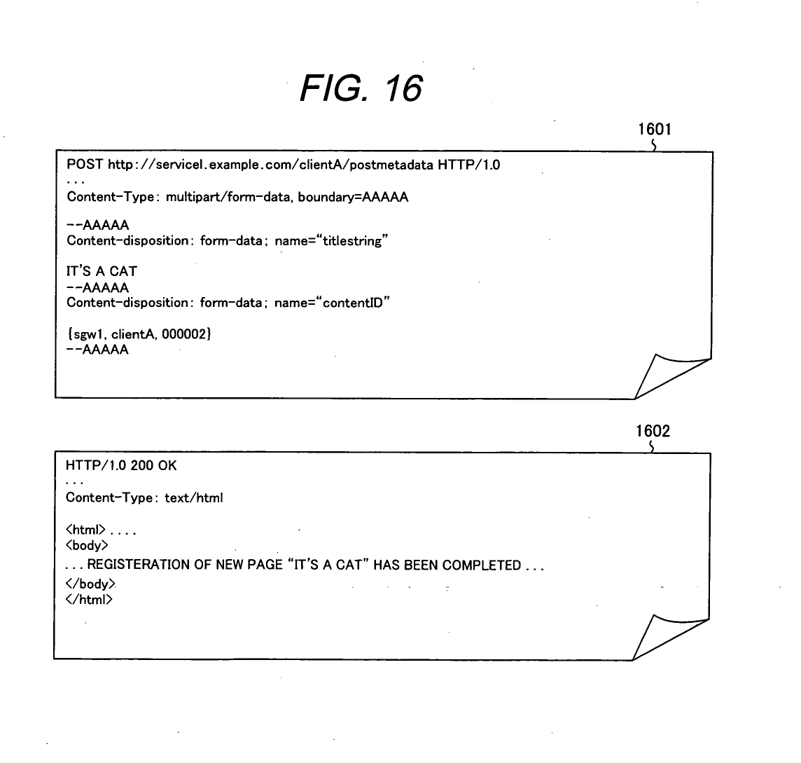

As a result, metadata is firstly sent to the server 106 (1006). The message sent in the process 1006 is shown in the message 1601 in FIG. 16. The server 106 that has received the message 1601 executes the server logic included in the third entry included in the generation logic/contents storage table 511 according to the flow process shown in FIG. 8, and replies with the generated content (1007). The service gateway 1 103-1 generates a reply page, and sends the generated reply page to client A 101-1 (1008).

It has been described above according to the first embodiment that the content is stored in the personal storage 401 of the service gateway 103 so that the server 106 may manage the location information of the content.

### Second Embodiment

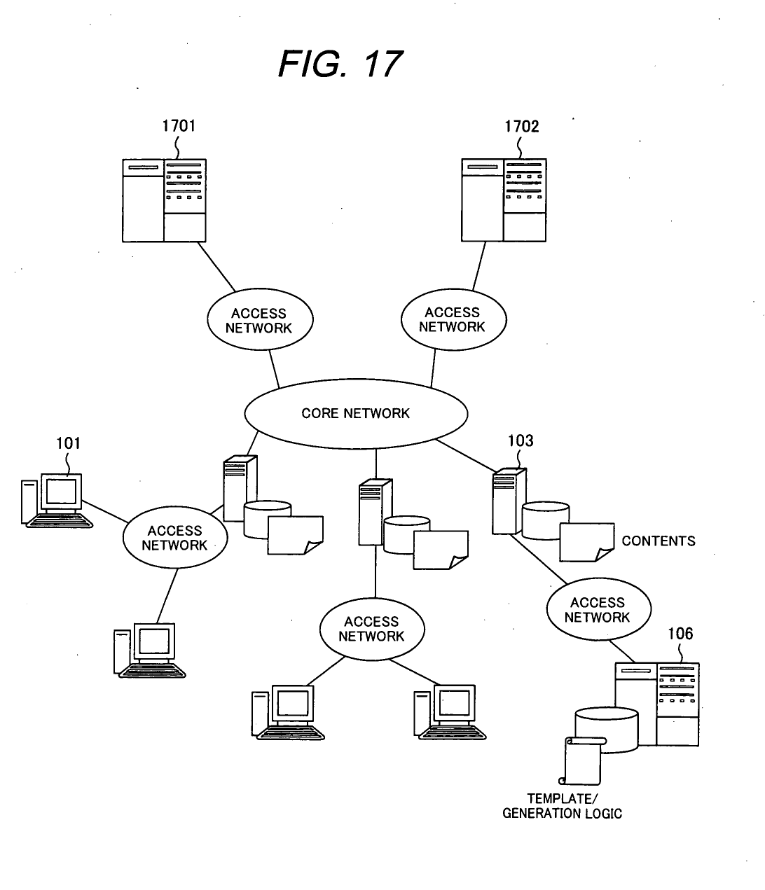

A second embodiment that achieves the insertion of an advertisement into contents will be described hereafter. The difference from the first embodiment lies in that an advertisement server 1701 for managing an advertisement manuscript and a user attribute server 1702 for managing a user attribute are added to the configuration as shown in FIG. 17, a region for embedding the advertisement is defined in the template provided as a reply from the server 106, and a program that extracts the attribute from the user ID and obtains the advertisement based on the attribute is added to the generation logic.

Even though the advertisement server 1701 and the user attribute server 1702 are located in different access networks as shown in FIG. 17, the present invention is not limited to this configuration. For example, the advertisement server 1701 and the user attribute server 1702 may be placed at any location as long as they can be reached through a network. Moreover, the functions corresponding to the advertisement server 1701 and the user attribute server 1702 may be mounted in the service gateway 103 or server 106.

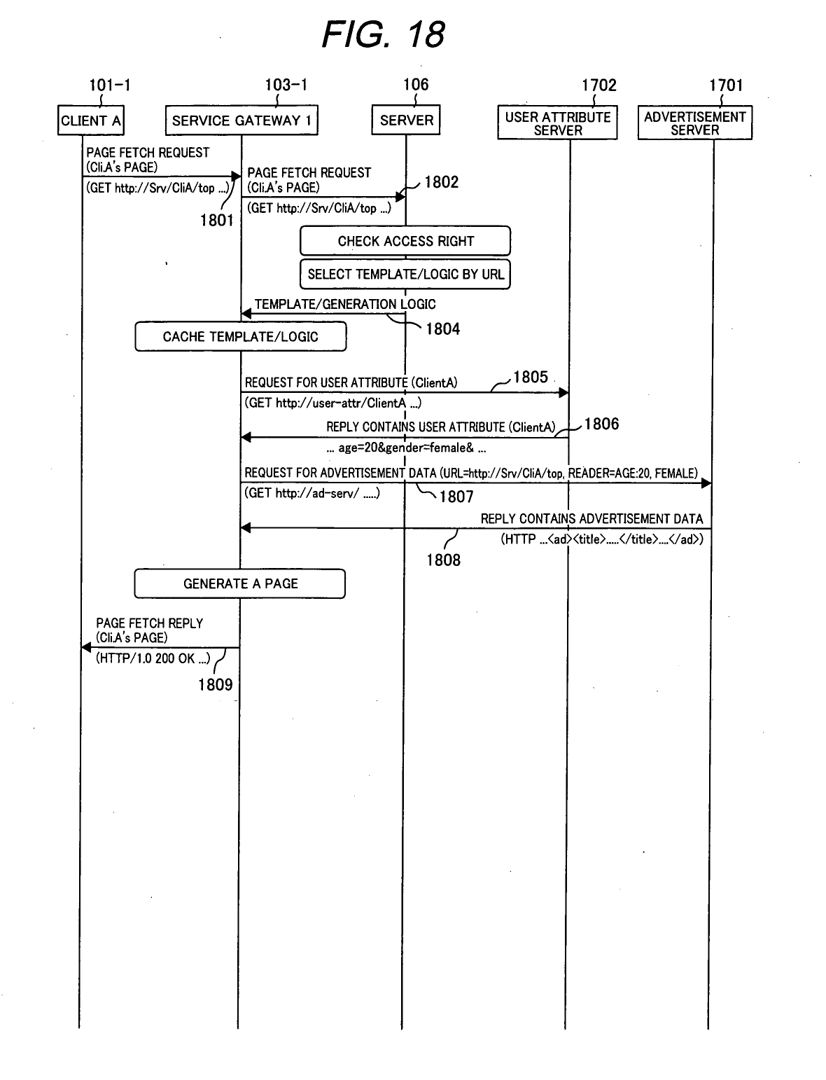

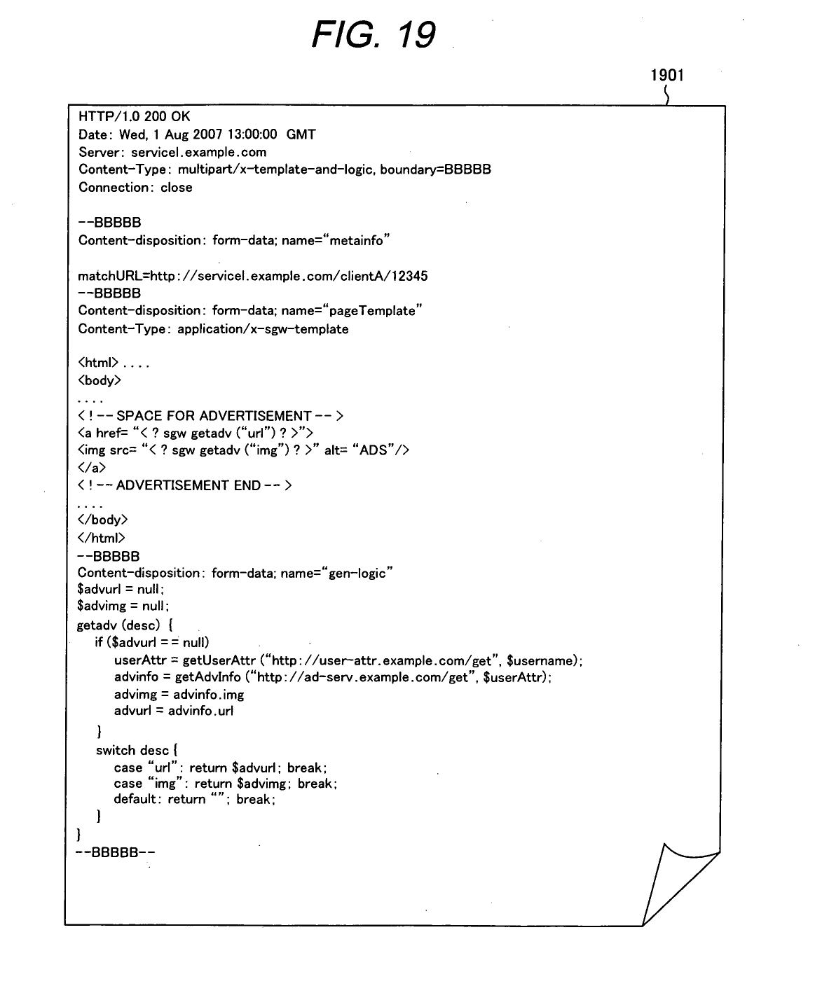

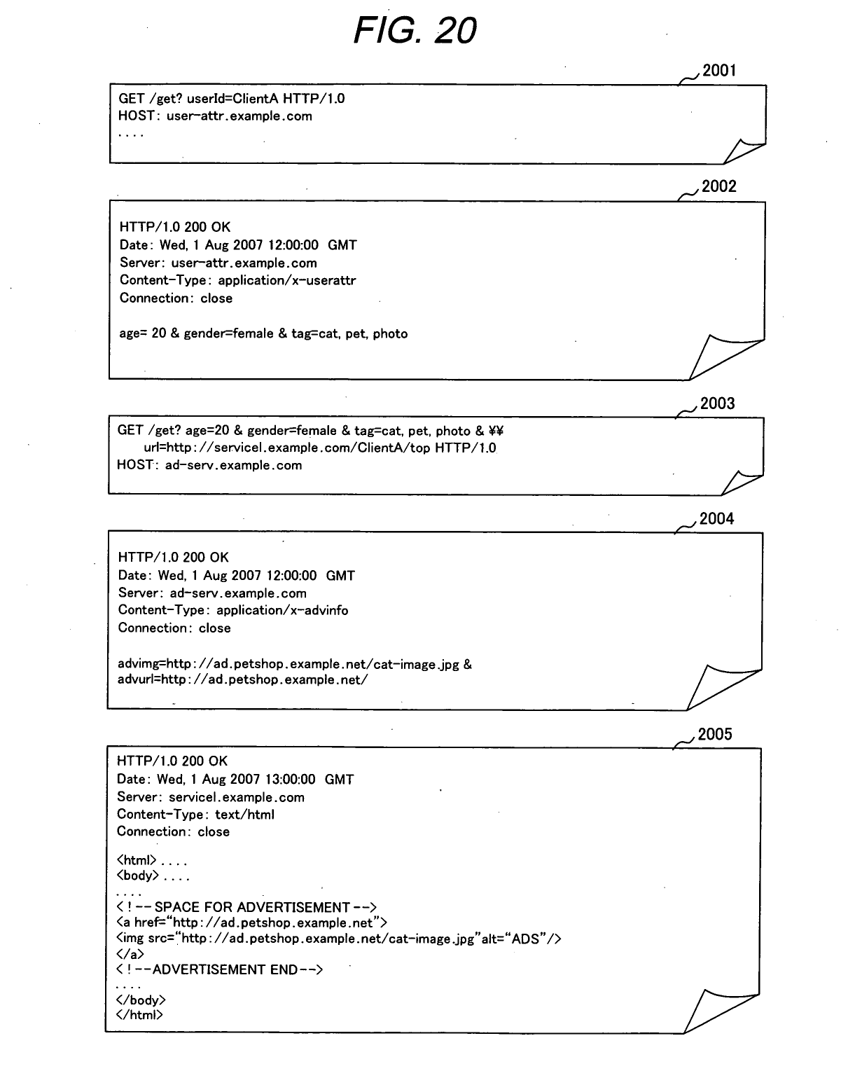

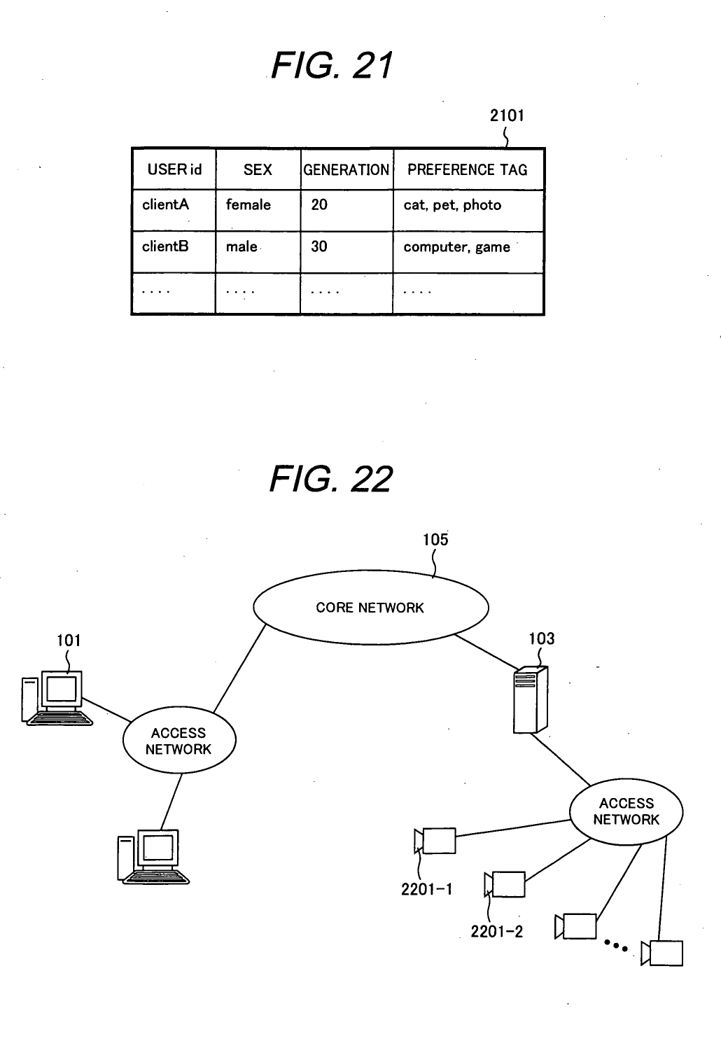

FIG. 18 shows a typical example of the sequence when an advertisement is inserted according to this embodiment. The client A 101-1 sends a request to the server 106 through the service gateway 1 103-1 to acquire a page (1801 and 1802). The server that has received the message performs the same process as that in the first embodiment, and replies with a message including the template defining a region for embedding the advertisement and the generation logic describing an advertisement fetch method (1804). An example of the message sent during process 1804 is shown as reference numeral 1901.

When receiving the reply, the service gateway 1 103-1 starts the generation of the page which includes the advertisement according to the generation logic. First of all, the service gateway 1 103-1 sends a user attribute fetch request to the user attribute server 1702 according to the instruction included in the template (1805). A user ID is included in this request. An example of this request message is shown in the reference numeral 2001. In this example, the user ID referred to as “Client A” is described in the first row of the request message. The user attribute server 1702 retrieves the user's attribute (age and sex, etc.) from the user ID by using the user attribute table 2101 and replies with the user's attribute (1806). An example of the reply message is shown in the reference numeral 2003. Here, the user's attribute is described in the body of the reply. The service gateway 1 103-1 sends the received attribute and the URL of a page to be generated to the advertisement server 1701 (1807). An example of the message sent during process 1807 is shown as reference numeral 2003.

The advertisement server 1701 selects an advertisement applicable for the page from the URL of the page and the user attribute, and replies with the URL of an image displayed in the advertisement and the URL of the previous site guiding to the advertisement (1808). An example of the message sent during process 1808 is shown as reference numeral 2004. The service gateway 103-1 embeds received information into the template according to the generation logic to generate a page. And, the service gateway 1 103-1 replies to client A 101-1 with the generated page. An example of the reply message is shown as reference numeral 2005. The part of the template represented as “<?sgw . . . ?>” included in the message 1901 is replaced by the URL of the advertisement in this example.

It has been described that the advertisement is inserted based on the attribute of the client and the attribute of the page according the abovementioned procedure. Since the method where a user ID is not forwarded directly to the side of the advertisement server 1701 is adopted in this embodiment, a leak of personal information may be suppressed. A service provider who provides services through the server 106 has an advantage because a service provider is capable of controlling the parts in which the advertisements have been inserted in detail by using the template.

### Third Embodiment

An image monitoring system with a Web camera will be described according to the third embodiment.

FIG. 22 shows a constructional view of a network that this embodiment targets. A service gateway 103 is disposed between a core network and an access network to which plural Web cameras 2201 are connected to relay a request from a client 101 belonging to another access network to the Web camera 2201. In this embodiment, the Web camera 2201 plays a role as the server described in the first embodiment so that the client 101 may perform image monitoring by continuously fetching picture files from a group of Web cameras 2201.

If this image monitoring is performed by the conventional system without the service gateway 103, the client 101 fetches the image without considering the importance of the image and the precedence with other camera groups, which may cause the traffic flowing in the core network to increase.

In this embodiment, the service gateway 103 is placed at a position near the camera group 2201 over a network to judge the precedence so as to control the reply to the client 101. As a result, the adjustment of the reply precedence may be made between two or more camera groups 2201, thus making it possible to perform image monitoring having high quality while with less traffic.

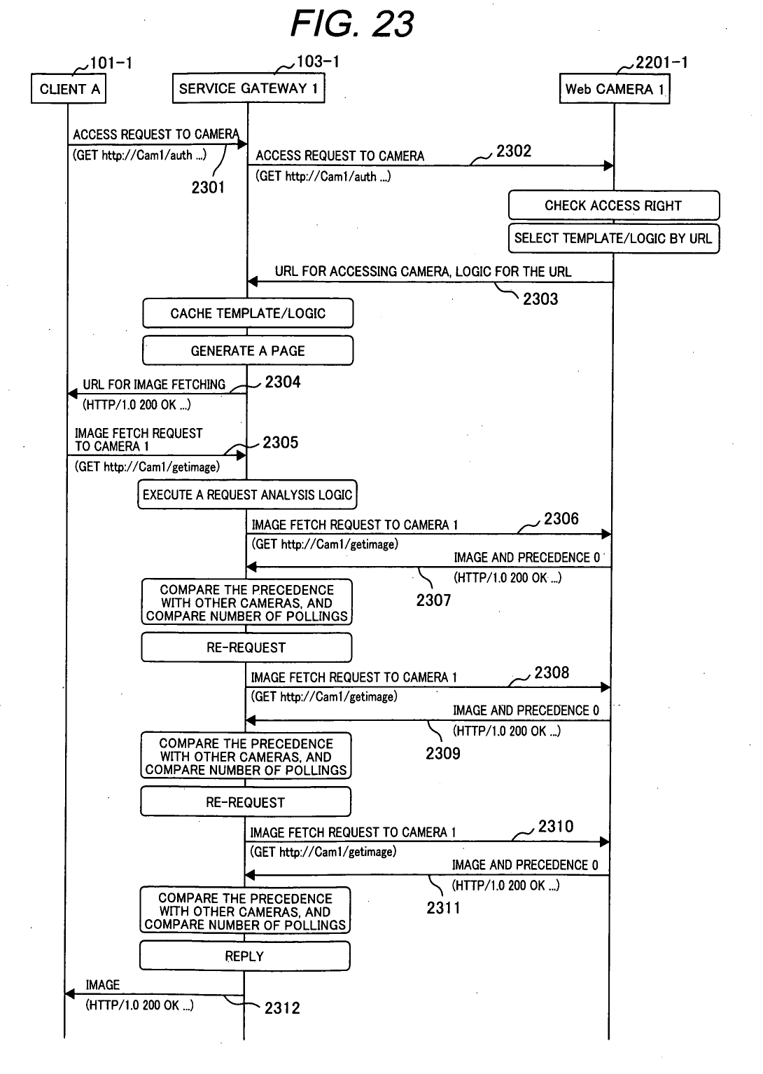

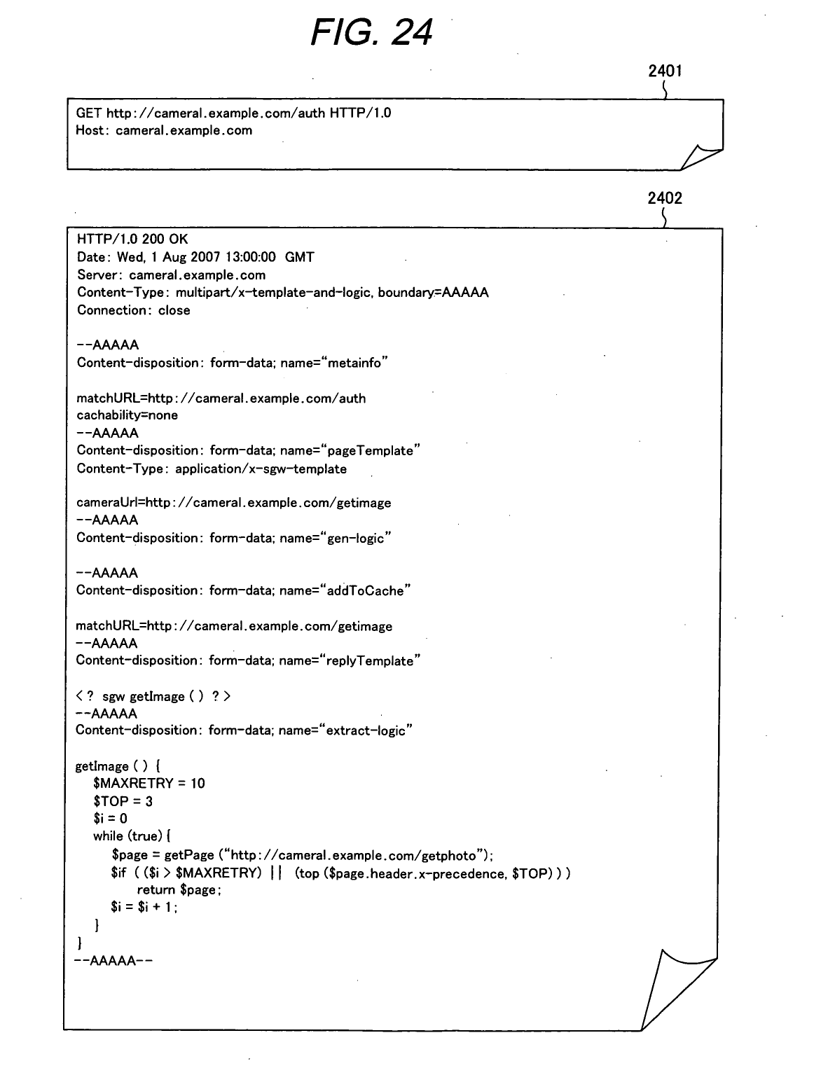

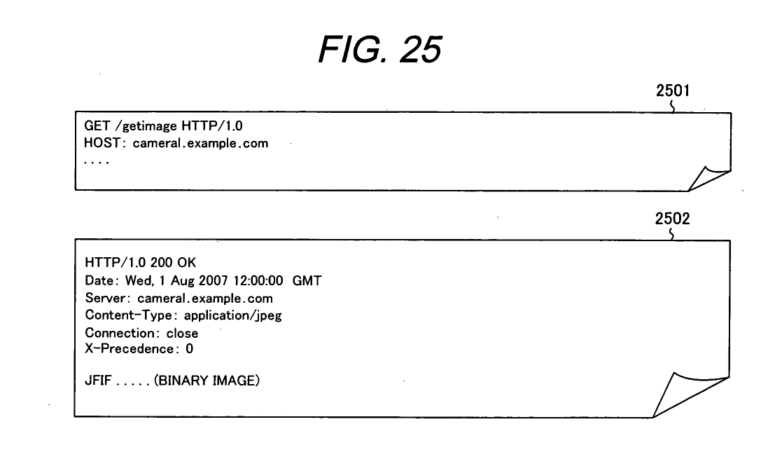

Hereafter, the processing content of this embodiment will be described according to the representative sequence shown in FIG. 23. The client 101 sends an access request to the Web camera 2201-1 via the service gateway 103 to gain access to the Web camera 2201-1 (2301 and 2302). An example of the message sent in processes 2301 and 2302 is shown as reference numeral 2401.

In response to the request, the Web camera 2201-1 checks the permitted access in a processing unit embedded therein, selects the template/logic for the URL when the access is permitted, and replies the service gateway 103 (2303). An example of the reply message sent during process 2303 is shown as reference numeral 2402. The message includes the URL for fetching an image from the Web camera 2201, the template upon access to the URL, and the logic, which serve as information for the image fetch request.

The service gateway 103 caches the template/logic included in the message 2402, and replies to the client 101 with the URL for the image fetch request, which is information for the image fetch request (2304).

The client 101 sends an image fetch request to the Web camera 2201-1 by using the URL included in the reply message (2305). An example of the message sent during process 2305 is shown as reference numeral 2501.

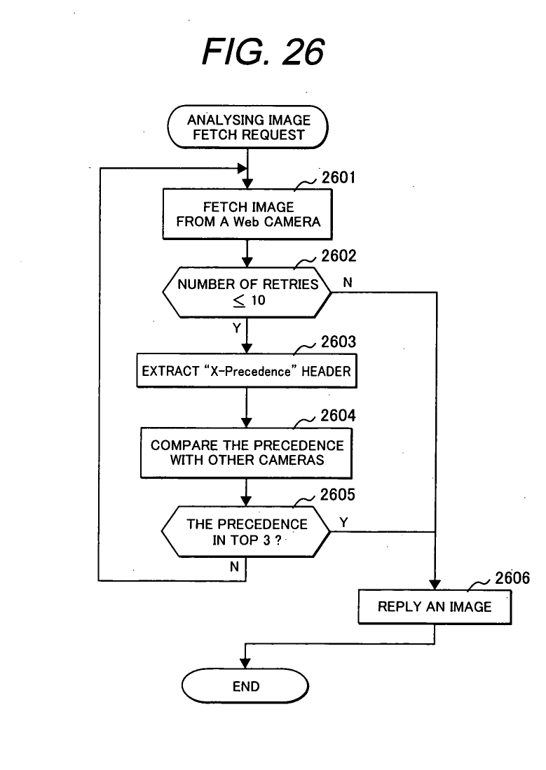

The service gateway 103 which relays the image fetch request initiates the analysis of the request. FIG. 26 shows a flowchart of analysis logic included in the message 2402. To begin with, the service gateway 103 performs image fetch request from the Web camera 2201-1 in step 2601. The service gateway 103 performs the following determination to determine whether this image should be provided as a reply. The service gateway 103 determines repetition frequency of the image fetch in step 2602 (step 2602) and replies with the image when the image fetch is repeatedly performed at a predetermined repetition frequency (10 times herein) (step 2606). At this time, it is determined if the image should be returned due to the frequency of the level, such as having low precedence. The service gateway 103 extracts the image precedence information included in the reply message 2401 in step 2603 (step 2603).

The image precedence information is stored in the reply header “X-Precedence” in this embodiment. Then, the service gateway 103 makes a comparison with the recent image precedence of another camera group 2201, which is accommodated in the service gateway 103 in step 2604, and when the camera is determined to belong to the group with high precedence (here, top three cameras) (step 2605), replies with the image (step 2606). Otherwise, the service gateway 103 returns the process to step 2601.

The client 101 sends the following image fetch request immediately after receiving the reply of the image. Repeating this procedure enables the client 101 to continuously receive the image from the Web camera 2201 and use the received image as a moving picture.

It has been described above that the image is fetched at a constant frequency between the service gateway 103 and the Web camera 2201 according to the abovementioned procedure, and the precedence of the information transmission is adjusted between a number of cameras in between the service gateway 103 and the client 101, such that data with low precedence is provided as a reply to the client 101 at low frequency and data with high precedence is provided as a reply to the client 101 at high frequency.

The inventive system that has been described above according to various embodiments may be used for the overall service provided over the network.

What is claimed is:

1. A service providing system where a client, a service gateway, and a server are connected to each other through a network,
wherein the client sends a first message to the server through the service gateway,
the service gateway inquires a processing method of the first message from the client of the server by using a second message including the content of the first message,
the server replies to the inquiry from the service gateway with the processing method, and
the service gateway performs a process of the first message based on the received processing method.

2. The service providing system according to claim 1,
wherein the service gateway includes a storage unit which stores the processing method received from the server.

3. The service providing system according to claim 1,
wherein the service gateway includes a storage unit which stores a reply message to the client generated according to the received processing method.

4. The service providing system according to claim 1,
wherein the service gateway includes a storage unit which stores a part or the whole of the first message from the client that is analyzed according to the processing method.

5. The service providing system according to claim 4,
wherein the service gateway allocates a unique identifier to the data stored in the storage unit in the service gateway, and sends the identifier to the server.

6. The service providing system according to claim 1,
wherein the service gateway identifies the client with an authorization token included in the first message and determines whether to process a request by using the authorization token.

7. The service providing system according to claim 1,
wherein the server expresses the processing method as a group of templates for the reply messages to the client and generation logic for embedding a blank of the template.

8. The service providing system according to claim 1,
wherein the server includes generation logic that describes a method of acquiring information necessary to generate a reply message to the client from an external server as the processing method.

9. The service providing system according to claim 1,
wherein the server is a Web camera, and the processing method includes information for image fetch request to fetch an image from the Web camera.

10. A service gateway connected to a client and a server through a network, comprising:
a processing unit;
a storage unit; and
a network interface,
wherein the network interface receives a first message sent from the client to the server,
the processing unit inquires a processing method of the first message of the server by using a second message including the content of the first message, receives the processing method provided as a reply from the server, processes the first message based on the received processing method, and sends a generated reply message to the client.

11. The service gateway according to claim 10,
wherein the processing unit stores the processing method received from the server in the storage unit.

12. The service gateway according to claim 10,
wherein the processing unit stores the reply message in the storage unit.

13. The service gateway according to claim 10,
wherein the processing unit stores a part or the whole of the first message from the client that is analyzed according to the processing method in the storage unit.

14. The service gateway according to claim 10,
wherein the processing unit allocates a unique identifier to data stored in the storage unit and sends the identifier to the server.

15. The service gateway according to claim 10,
wherein the processing unit identifies the client with an authorization token included in the first message.

16. The service gateway according to claim 15,
wherein the processing unit determines whether to perform a process by using the authorization token of the client.

17. A server connected to a client via a service gateway through a network, comprising:
a processing unit;
a storage unit; and
a network interface,
wherein the network interface receives a second message including the content of a first message to inquire a processing method of the first message from the service gateway that has received the first message that is sent from the client to the server, and
the processing unit generates the processing method of the first message based on the second message.

18. The server according to claim 17,
wherein the processing unit groups the generated processing method together with templates for the reply message to the client and generation logic for embedding a blank of the template.

19. The server according to claim 17,
wherein the processing unit includes generation logic that describes a method of acquiring information necessary to generate the reply message to the client from an external server as the generated processing method.

20. The server according to claim 17,
wherein the processing unit determines whether or not the client gains access on the basis of an authorization token included in the second message.
